(19) United States
(12) Patent Application Publication
(10) Pub. No.: US 2017/0161745 A1
(43) Pub. Date: Jun. 8, 2017

(54) PAYMENT ACCOUNT FRAUD DETECTION USING SOCIAL MEDIA HEAT MAPS

(71) Applicant: MasterCard International Incorporated, Purchase, NY (US)

(72) Inventor: Tammy HAWKINS, St. Charles, MO (US)

(21) Appl. No.: 14/957,870

(22) Filed: Dec. 3, 2015

(51) Int. Cl. G06Q 20/40; H04L 29/08; G06Q 50/00

(52) U.S. Cl. CPC G06Q 20/4016; G06Q 50/01; H04L 67/18

(57) ABSTRACT

According to some embodiments, a fraud detection computer server may collect information associated with a plurality of social media accounts over a period of time. A sub-set of social media accounts meeting a potential fraud threshold associated with at least one type of payment account may be determined, and, for each of the sub-set of social media accounts meeting the potential fraud threshold, the fraud detection computer server may determine a geographic location associated with the social media account. A map display may then be rendered to indicate the geographic locations of the sub-set of social media accounts meeting the potential fraud threshold.

### FIELD OF THE INVENTION

Embodiments disclosed herein relate to methods, apparatus and systems that use social media heat maps to facilitate payment account fraud detection.

### BACKGROUND

Payment card systems are in widespread use. A prominent payment card system is operated by the assignee hereof, MasterCard International Incorporated, and by its member financial institutions. To initiate a transaction, a customer may visit a retail store operated by a merchant, select goods that he/she wishes to purchase, and present his or her payment card to a merchant's Point Of Sale (“POS”) terminal. The POS terminal reads the customer's payment card account number from the payment card, and then sends an authorization request to an acquirer platform associated with a financial institution with which the merchant has a relationship. The authorization request typically includes the payment card account number, the amount of the transaction and other information, such as merchant identification and location. The authorization request message is routed via a payment system authorization platform (which may be, for example, the well-known Banknet™ system operated by MasterCard International Incorporated) to an issuer platform of the issuer financial institution that issued the customer's payment card.

Assuming that all is in order, the issuer platform may transmit a favorable authorization response to the acquirer platform through the payment system authorization platform. The transaction at the POS is then completed and the customer leaves the store with the goods. A subsequent clearing transaction initiated by the merchant results in a transfer of the transaction amount from the customer's payment card account to an account that belongs to the merchant. The customer's payment card account may be, for example, either a debit card account or a credit card account. In the former case, the clearing transaction results in the funds being debited directly from the account. In the latter case, the clearing transaction results in a charge being posted against the account, and the charge subsequently appears on the customer's monthly credit card statement.

The foregoing description of the typical transaction may be considered to be somewhat simplified in some respects. For example, a merchant processing system may be interposed between the POS terminal and the acquirer platform. As is familiar to those who are skilled in the art, a merchant processing system may be operated by or on behalf of the merchant to form part of the communications path between the acquirer platform and a considerable number of POS terminals operated by the merchant. It is also often the case that a third party transaction processing service, such as a Payment Services Provider (“PSP”), may operate to handle payment card transactions on behalf of the acquirer and on behalf of a large number of other like financial institutions.

In addition to POS transactions, the acquirer platform may process transactions associated with Automated Teller Machine (“ATM”) withdrawals and Card Not Present (“CNP”) online transactions in a similar manner.

In some cases, a fraudulent transaction may be processed via a payment account. For example, a party might have determined a credit card number, expiration date, Card Verification Value (“CVV”) number, etc. and used this information to make unauthorized purchases (either at a merchant or via an online transactions). The payment cardholder, acquirer and issuer financial institutions, and payment system authorization platforms all have an interest in reducing fraudulent transactions. Detecting patterns in fraudulent transaction might be useful to help prevent additional fraudulent transaction from occurring. For example, if it could be determined that fraudulent transactions have recently increased in or near a particular town, future transactions originating from that area could be more closely reviewed. It can be difficult, however, to detect such patterns in substantially real time.

The present inventors have recognized that there is a need for methods and/or systems to facilitate payment account fraud detection.

### BRIEF DESCRIPTION OF THE DRAWINGS

FIG. 1 is a block diagram view of a system in accordance with some embodiments.

FIG. 2 is a payment system authorization method that may be performed in accordance with some embodiments.

FIG. 3 illustrates a smartphone social media display according to some embodiments.

FIGS. 4 through 8 illustrate payment account fraud detection social media heat map displays in accordance with various embodiments.

FIG. 9 is a fraud detection computer server that may be provided in accordance with some embodiments.

FIG. 10 is a tabular portion of a fraud data computer store that may be provided in accordance with some embodiments.

FIG. 11 is a block diagram view of a system in accordance with some embodiments.

FIG. 12 illustrates a payment account fraud detection social media heat map display according to some embodiments.

### DETAILED DESCRIPTION

In general, and for the purpose of introducing concepts of embodiments of the present invention, a “payment account” may be used to process transactions. As used herein, the phrase “payment account” might be associated with, for example, a credit card, a debit card, a loyalty program card, a badge, a license, a passport card, a radio frequency apparatus, a smartphone, and/or a contactless card.

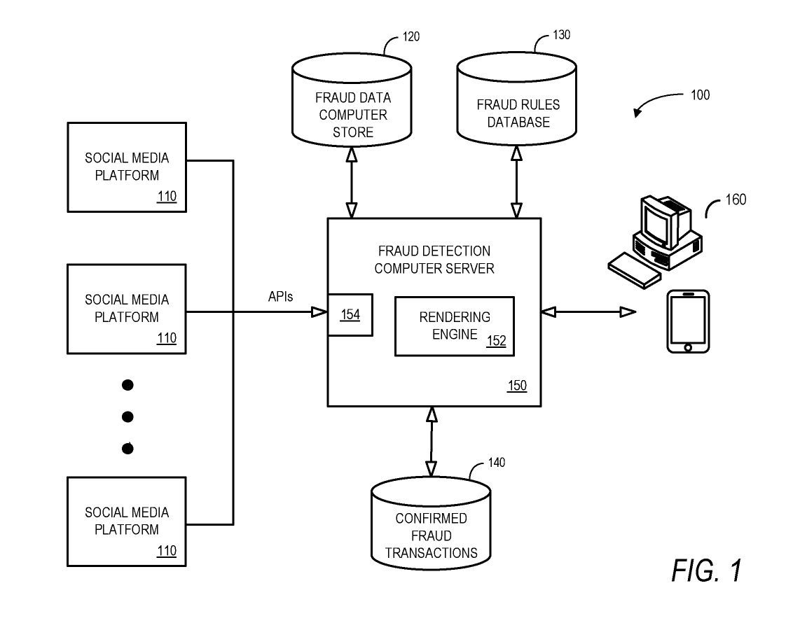

FIG. 1 is block diagram of a system 100 according to some embodiments of the present invention. In particular, the system 100 includes a fraud detection computer server 150 that may access social media platforms 110. Each social media platform 110 may be associated with community, social, and/or business network based data such as information published by individuals or businesses (e.g., via Twitter, Facebook, Google+, or the like), as well as information shared by individuals or businesses via applications, memberships, or the like. For illustrative, but not limiting, purposes such information may be published by sites or networks including ebay.com, Facebook.com, LinkedIn.com, Twitter.com, Blogger.com, MySpace.com, Friendster.com, Google+, Instagram, Tumblr, SnapChat, Yik Yak, and other similar sites.

The fraud detection computer server 150 may use one or more Application Programming Interfaces (“APIs”) to collect information from the social media platforms 110 via a communication channel 154. According to some embodiments, the communication channel may further incorporate security features, load balancing functionality, etc.

The fraud detection computer server 150 may store information collected from the social media platforms 110 in a fraud data computer store 120 or database. The fraud detection computer server 150 may access information in a fraud rules database 130 to determine whether or not a social media account has an increased likelihood of being associated with payment account fraud. The fraud detection computer server 150 may, for example, store this information in a local database. According to some embodiments, the fraud detection computer server 150 is associated with a credit card company.

The fraud detection computer server 150 may receive a request for a payment account fraud detection social media heat map display from a requestor device 160. For example, an administrator or operator might use his or her desktop computer or smartphone to submit the request to the fraud detection computer server 150. According to some embodiments, information about received requests (e.g., user preference data) may be stored at the fraud detection computer server 150. Responsive to the request, the fraud detection computer server 150 rendering engine 152 to render user displays on the requesting devices 160. According to some embodiments, the administrator or operator may access secure payment account fraud detection information through a validation process that may include a user identifier, password, biometric information, device identifiers, and/or geographic authentication processes. According to some embodiments the fraud detection computer server 150 may further access confirmed fraud transaction 140 to improve the display and/or one or more predictive models.

The fraud detection computer server 150 and/or requestor devices 160 might be, for example, associated with a Personal Computer (“PC”), laptop computer, smartphone, an enterprise server, a server farm, and/or a database or similar storage devices. According to some embodiments, an “automated” fraud detection computer server 150 may facilitate payment account fraud detection. For example, the fraud detection computer server 150 may automatically render a map display that may be used to detect patterns of fraudulent transactions. As used herein, the term “automatically” may refer to, for example, actions or tasks that can be performed with little (or no) intervention by a human.

As used herein, devices, including those associated with the fraud detection computer server 150 and any other device described herein may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The fraud detection computer server 150 may store information into and/or retrieve information from the fraud data computer store 120. The fraud data computer store 120 might be associated with, for example, a credit card company or a banking institution. The fraud data computer store 120 may be locally stored or reside remote from the fraud detection computer server 150. As will be described further below, the fraud data computer store 120 may be used by the fraud detection computer server 150 to render a map display utilizing information received from social media platforms 110. According to some embodiments, the fraud detection computer server 150 communicates information associated with fraud detection to a remote payment processing device and/or to an automated system, such as by transmitting an electronic file to an bank, a fraud detection specialist, an email server, a workflow management system, a predictive model, a map application, etc.

Although a single fraud detection computer server 150 is shown in FIG. 1, any number of such devices may be included. Moreover, various devices described herein might be combined according to embodiments of the present invention. For example, in some embodiments, the fraud detection computer server 150 and fraud rules database 130 might be co-located and/or may comprise a single apparatus.

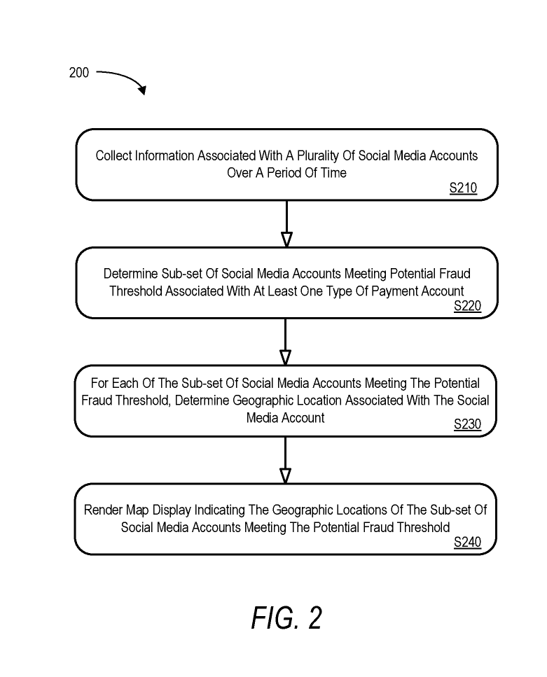

FIG. 2 illustrates a method 200 that might be performed by the fraud detection computer server 150 of the system 100 described with respect to FIG. 1 according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, the system may collect information associated with a plurality of social media accounts over a period of time. For example, the system might collect information associated with all United States twitter accounts that have posted a tweet during the past 48 hours. Note that according to some embodiments, information might be collected in connection with several different social media platforms. The collected information might include, for example, text information, image information, a social media post, a social media re-post, a social media message, and/or a social media rating indication (e.g., a “like” or star rating system).

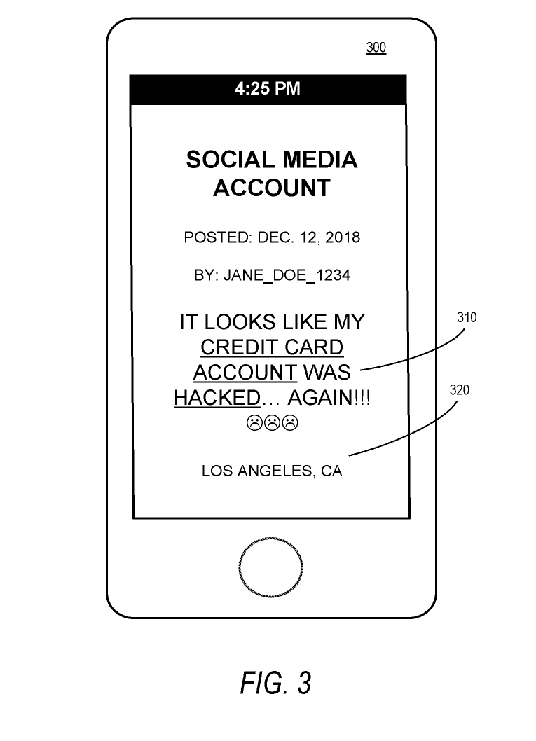

At S220, the system may determine a sub-set of social media accounts meeting a potential fraud threshold associated with at least one type of payment account (e.g., a credit card account, a debit card account, a bank account, a pre-paid stored value account, etc.). The potential fraud threshold might be associated with, for example, the presence of one or more key words or key phrases in the information collected for a social media account. For example, social media accounts that have posted a message including the phrase “credit card” and the word “hacked” might be automatically included in the sub-set. For example, FIG. 3 illustrates a smartphone 300 social media display that includes a text portion 310 that can be searched for key words and phrases according to some embodiments.

Referring again to FIG. 2, at S230 the system may determine a geographic location associated with each social media account in the sub-set of social media accounts meeting the potential fraud threshold. The geographic location information might be associated with, for example, a latitude and longitude, a ZIP code, a town, a state, a county, and a country. The geographic information might be determined from a social media post (e.g., a tweet might mention where the account owner is as illustrated by the address 320 in FIG. 3), a smartphone location, a device identifier, social media account information, etc.

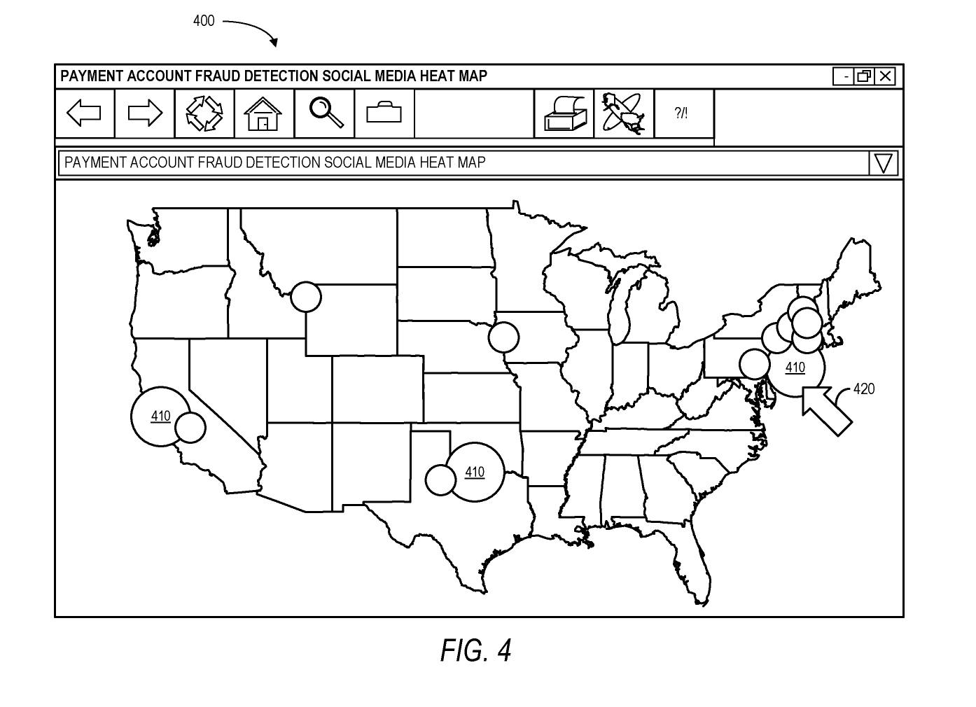

At S240, the system may render (e.g., in substantially real time) a map display indicating the geographic locations of the sub-set of social media accounts meeting the potential fraud threshold. According to some embodiments, the rendered map display includes icons selected based at least in part on a number of social media accounts meeting the potential fraud threshold in connection with a particular geographic location, wherein different icons may be associated with different: icon sizes, icon shapes, and icon colors. For example, FIG. 4 illustrates a payment account fraud detection social media “heat map” display 400 in accordance with various embodiments. As used herein, the phrase “heat map” may refer to, for example, any map display capable of displaying geographic location information in connection with payment account fraud detection. In the display 400 of FIG. 4, circular icons 410 are displayed where social media users have posted information that is likely to be associated with payment account fraud, with larger icons 410 being associated with larger numbers of users, an increased likelihood that fraud actually occurred, etc. According to some embodiments, a user might select an icon 410 with his or her computer pointer 420 to “drill down” and see more information about the potential payment account fraud (e.g., how many posts occurred in the last 24 hours in that area, what key words were most frequently detected, etc.).

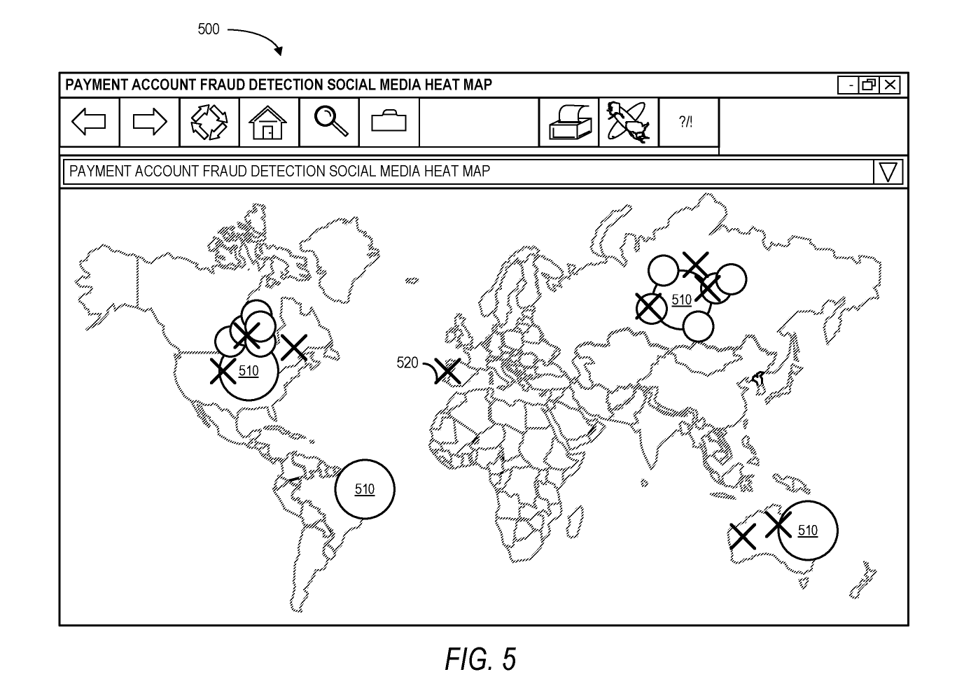

According to some embodiments, a fraud detection computer server is further programmed to retrieve information about confirmed fraud transactions that have occurred and display information about the confirmed fraud transactions on the map display. For example, FIG. 5 illustrates a payment account fraud detection social media heat map display 500 in accordance with various embodiments. As before, circular icons 510 are displayed where social media users have posted information that is likely to be associated with payment account fraud, with larger icons 510 being associated with larger numbers of users, an increased likelihood that fraud actually occurred, etc. According to this embodiment, an “X” icon 520 is displayed where it has been confirmed that payment account fraud has been confirmed to have previously occurred.

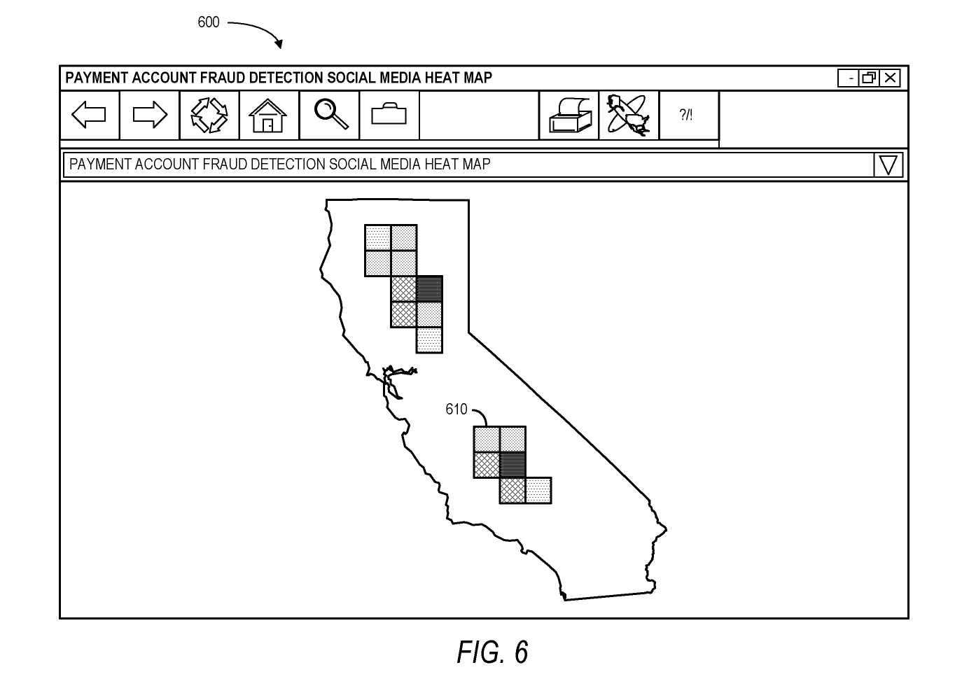

According to some embodiment, an icon color or shading may be used to convey payment account fraud information. For example, FIG. 6 illustrates a payment account fraud detection social media heat map display 600 in accordance with various embodiments. In this display, the shading of pixel block icons 610 may be changed (e.g., with darker pixel block icons 610 meaning that more social media accounts have been posting about payment account fraud). In other cases, pixel block icon color might be adjusted (e.g., with red pixel blocks icons representing more posting activity as compared to green pixel block icons).

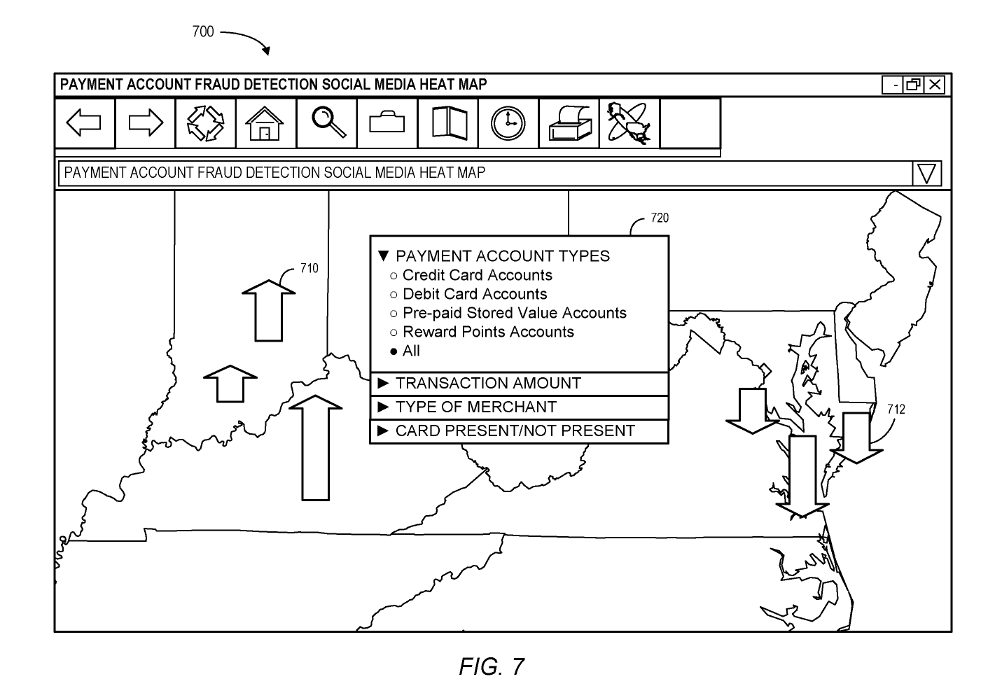

According to some embodiments, a rendered map display includes icons selected based at least in part on a “change” in a number of social media accounts meeting the potential fraud threshold in connection with a particular geographic location, and different icons may be associated with different: icon sizes, icon shapes, and icon colors. For example, FIG. 7 illustrates a payment account fraud detection social media heat map display 700 in accordance with various embodiments. In this example, the display includes “up arrow” icons 710 (with larger arrows meaning a more rapidly rising trend in social media posts) and “down arrow” icons 720 (with larger arrows meaning a more rapidly falling trend in social media posts). For example, an area reporting five social media posts likely associated with payment account fraud in a particular ZIP code two days ago and ten social media posts likely associated with payment account fraud in that ZIP code one day ago might receive a substantially large up arrow icon 710 (e.g., because the number of posts doubled in a single day). According to some embodiments, a user may define at least one of: the period of time associated with the map display, the plurality of social media accounts (e.g., all twitter and Instagram accounts in Florida), the at least one type of payment account (e.g., only display information about credit and debit cards and not information about pre-paid stored value cards), and the potential fraud threshold (e.g., only display social media posts rated as being 80% or higher as likely to be associated with payment account fraud). In the display 700 of FIG. 7, a user preference area 720 may be customized based on his or her interests (e.g., only include confirmed transaction if the transaction amount was over $50).

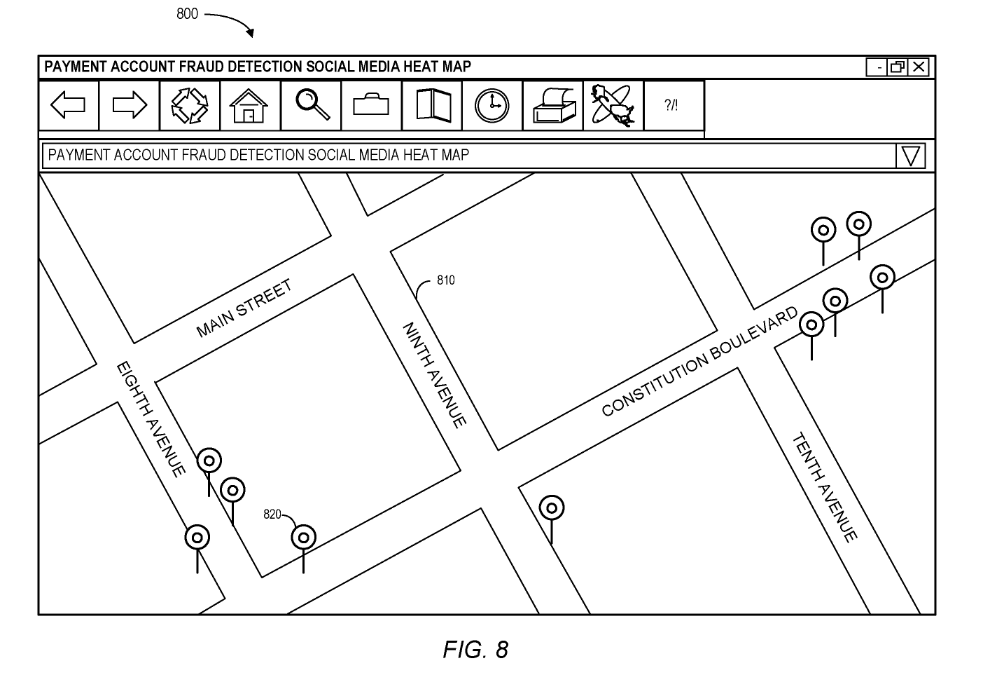

Note that the types of map displays provided herein are only illustrations and any other level of detail, types of icons, etc. could be instead be provided. For example, FIG. 8 illustrates a payment account fraud detection social media heat map display 800 in accordance with various embodiments. In this example, city streets 810 may be included to more closely monitor social media post pin icons 820 that are likely to be associated with payment account fraud. Note that the color, size, etc. of the pin icons might represent how many posts were from a particular apartment building, how long ago the posts were made, etc.

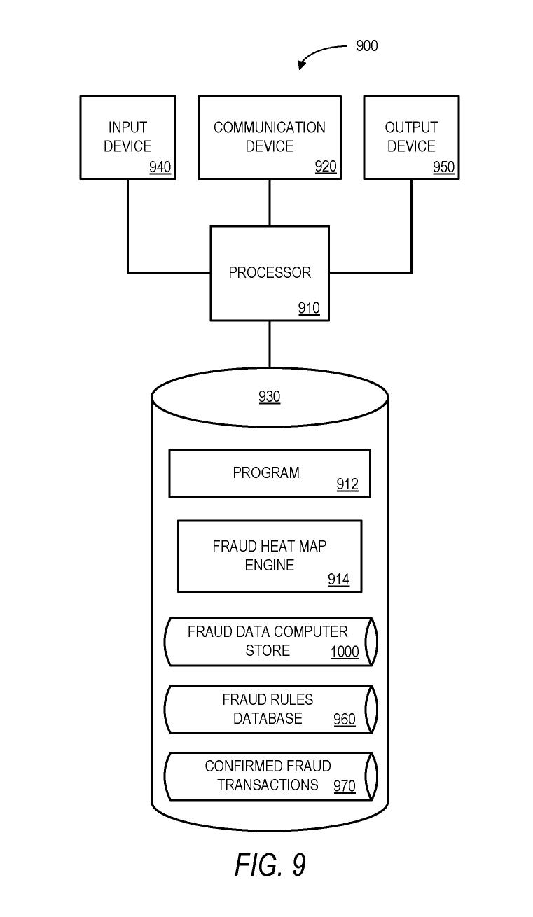

The embodiments described herein may be implemented using any number of different hardware configurations. For example, FIG. 9 illustrates a fraud detection computer server 900 that may be, for example, associated with the system 100 of FIG. 1. The fraud detection computer server 900 comprises a processor 910, such as one or more commercially available Central Processing Units (“CPUs”) in the form of one-chip microprocessors, coupled to a communication device 920 configured to communicate via a communication network (not shown in FIG. 9), such as by exchanging information with social media platforms and/or display devices). The fraud detection computer server 900 further includes an input device 940 (e.g., a mouse and/or keyboard to enter fraud detection rules and logic) and an output device 950 (e.g., a computer monitor and a printer to generate reports).

The processor 910 also communicates with a storage device 930. The storage device 930 may comprise any appropriate information storage device, including combinations of magnetic storage devices (e.g., a hard disk drive), optical storage devices, mobile telephones, and/or semiconductor memory devices. The storage device 930 stores a program 912 and/or a fraud heat map engine 914 for controlling the processor 910. The processor 910 performs instructions of the programs 912, 914, and thereby operates in accordance with any of the embodiments described herein. For example, the processor 910 may collect information associated with a plurality of social media accounts over a period of time. A sub-set of social media accounts meeting a potential fraud threshold associated with at least one type of payment account may be determined by the processor 910, and, for each of the sub-set of social media accounts meeting the potential fraud threshold, the processor 910 may determine a geographic location associated with the social media account. A map display may then be rendered by the processor 910 to indicate the geographic locations of the sub-set of social media accounts meeting the potential fraud threshold.

The programs 912, 914 may be stored in a compressed, uncompiled and/or encrypted format. The programs 912, 914 may furthermore include other program elements, such as an operating system, a database management system, and/or device drivers used by the processor 910 to interface with peripheral devices.

As used herein, information may be “received” by or “transmitted” to, for example: (i) the fraud detection computer server 900 from another device; or (ii) a software application or module within the fraud detection computer server 900 from another software application, module, or any other source.

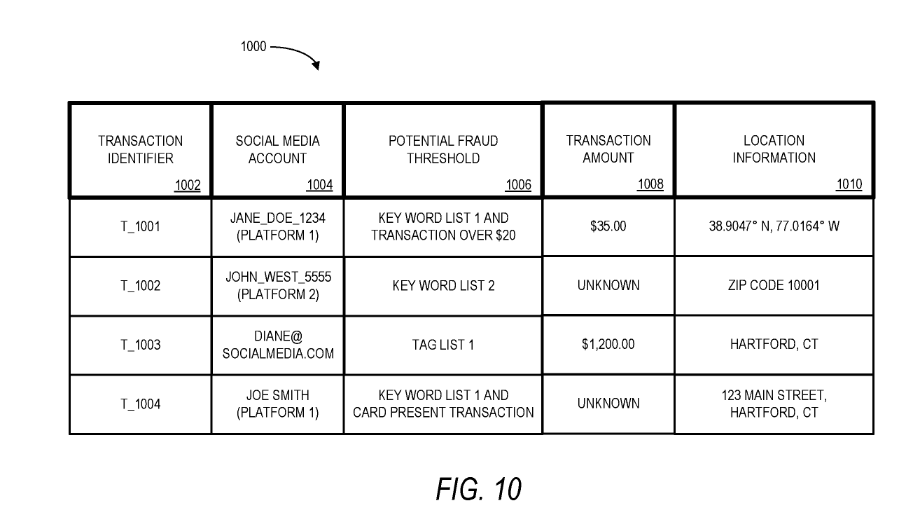

In some embodiments (such as shown in FIG. 9), the storage device 930 further stores a fraud data computer store 1000, a fraud rules database 960, and confirmed fraud transactions 970. An example of a database that may be used in connection with the fraud detection computer server 900 will now be described in detail with respect to FIG. 10. Note that the database described herein is only one example, and additional and/or different information may be stored therein. Moreover, various databases might be split or combined in accordance with any of the embodiments described herein.

Referring to FIG. 10, a table is shown that represents the fraud detection computer store 1000 that may be stored at the fraud detection computer server 900 according to some embodiments. The table may include, for example, entries identifying social media posts meeting pre-determined fraud detection criteria. The table may also define fields 1002, 1004, 1006, 1008, 1010 for each of the entries. The fields 1002, 1004, 1006, 1008, 1010, may, according to some embodiments, specify: a transaction identifier 1002, a social media account 1004, a potential fraud threshold 1006, a transaction amount 1008, and location information 1010. The fraud detection computer store 1000 may be created and updated, for example, based on information received from social media platforms and a fraud rules database.

The transaction identifier 1002 may be a unique alphanumeric code associated with a particular social media account or social media post. The social media account 1004 may identify, for example, a user name or other identifier associated with the post. The potential fraud threshold 1006 may include rules (e.g., associated with key words and phrases) and other criteria that may flag a social media post as likely to be associated with payment account fraud. The transaction amount 1008 might indicate the scope of the potential fraud (e.g., when, for example, that information was included in the social media post), and the location information 1010 might indicate where the social media account is located and/or where the user was when he or she posted to the social media account.

According to some embodiments, a fraud detection computer server may retrieve information about confirmed fraud transactions that have occurred and adjust at least one payment account fraud model in accordance with the information about confirmed fraud transactions that have occurred and/or the sub-set of social media accounts meeting the potential fraud threshold.

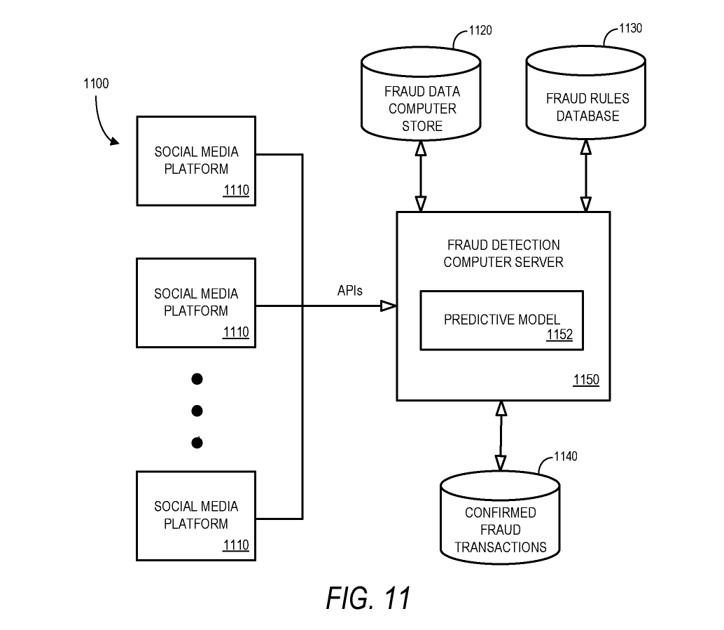

FIG. 11 is block diagram of a system 1100 according to some embodiments of the present invention. In particular, the system 1100 includes a fraud detection computer server 1150 that may access social media platforms 1110. Each social media platform 1110 (e.g., via Twitter, Facebook, Google+, or the like). The fraud detection computer server 1150 may use one or more APIs to collect information from the social media platforms 1110.

The fraud detection computer server 1150 may store information collected from the social media platforms 1110 in a fraud data computer store 1120 or database. The fraud detection computer server 1150 may access information in a fraud rules database 1130 to determine whether or not a social media account has an increased likelihood of being associated with payment account fraud. According to some embodiments, the fraud detection computer server 1150 is associated with a credit card company.

According to some embodiments the fraud detection computer server 1150 may further access confirmed fraud transaction 1140 to improve one or more predictive models 1152. The predictive models 1152 might, for example, help determine which social media posts are likely to be associated with payment account fraud, which actual transactions are likely to be associated with payment account fraud, etc. Note that a predictive model might be associated with other types of information including: card present transactions, card not present transactions (e.g., different rules or criteria might be applicable to card not present transactions as compared to card present transactions), cross border transactions, domestic transactions, retail shopper transactions, domestic automated teller machine transactions, cross border automated teller machine transactions, travel spending transactions, signature at personal identification number terminal transactions, automotive fuel dispenser transactions, online transactions, game transactions, gambling transactions, a transaction amount, and a transaction or social media post time of day.

In some embodiments, rules or logic might flag social media posts in a binary fashion (e.g., a particular post might be flagged as “likely” or “not likely” to be associated with the poster being a victim of payment account fraud). In other embodiments, posts or transactions might be associated with a risk score, a cardholder category, a terminal category, and/or enhanced expert monitoring service score data. Note that enhanced expert monitoring service score data is used herein only as an example and embodiments may provide information in any of a number of different ways. According to some embodiments, the system may supplement a score with a reason code (e.g., alpha-numeric “A1”) which can then be interpreted (e.g., by the issuer or merchant) in some pre-defined manner (e.g., “A1” is a cardholder category for Frequent Traveler). According to some embodiments, score data and or models may be associated with an application to monitor spending compliance (e.g., with governmental rules and regulations) and/or to combat fraud and misuse.

According to some embodiments, a rule or model is based on a travel category. For example a cardholder might be classified as an international traveler, an interstate traveler, or someone who never travels. This information can then be used to flag unusual activity (e.g., a card associated with someone who never travels is being used in a distant state or country). In addition to an extended cardholder view, embodiments might provide an expanded terminal view (e.g., for an ATM). For example, a rule might ask if current ATM activity is normal, whether or not the current ATM transaction fits within this cardholder's historical ATM pattern, how much he or she typically withdraws, how many withdrawals typically occur at that terminal (e.g., per day, per week, or per month), how many withdrawals typically occur by that cardholder (e.g., per day, per week, or per month) the single largest withdrawal by the cardholder, and/or whether the cardholder is traveling. In some case, the rule or model might be based on whether the cardholder has made any recent transactions with a travel merchant that would indicate he or she may be traveling in the future, how likely is it this is a counterfeit card, whether or not the transaction is typical (for this ATM terminal or holder), whether a particular issuer's cards have been used at that location, cards have not been used this frequently in the past, how much money is typically withdrawn (per hour, day, week, or month), and/or what was the largest amount withdrawn.

According to some embodiments, the rules or models may be based on an online spending category, whether or not the cardholder is a seasonal shopper, an established shopper, or someone who never shops online. Note that embodiments might review cardholder activity over a long enough time period to account for seasonal spending (e.g., Christmas, Valentine's Day, “Cyber Monday”), establish custom spend levels for each segment as well as within each segment, allow one to continually refresh this segmentation at a mutually desired frequency, and/or manage fraud detection strategies to optimize approvals while balancing fraud risk.

Note that the rules or models may be based on information about a terminal associated with a transaction, such as (i) a transaction frequency, (ii) a transaction amount, and/or (iii) a transaction location. Further note that the rules or models may be based on issuers other than an issuer associated with a transaction, a cardholder other than a cardholder associated with a transaction, and/or a terminal other than a terminal associated with a transaction.

Note that any of the analytics rules described herein may be associated with a wide variety of risk parameters. For example, cardholder and/or network level profiling may integrate data insights into real-time authorization and fraud strategies. Moreover, behavioral insight may be focused on merchant-level data that views activities across multiple payment card types. Examples of merchant-level profiling considerations include retail/spend categories (e.g., automobile fuel, bookstore purchases, subscription services, etc.) and spend category classifications (e.g., department stores, electric appliance stores, gasoline stations, mail order purchases, etc.). The analytics rules may also evaluate spending velocity parameters to look for transactions at an unusual volume at a particular time of day, unusual transaction amounts, and/or suspicious changes in approved and/or declined transaction volumes. According to some embodiments, historical ratios may be used to allow for variances across merchant chains or specific locations.

According to some embodiments, one or more predictive models 1152 may be used to detect payment account fraud and/or to flag or score social media posts. The predictive models 1152 include a data storage module. In terms of its hardware the data storage module may be conventional, and may be composed, for example, by one or more magnetic hard disk drives. A function performed by the data storage module is to receive, store and provide access to both historical transaction and/or posting data and current transaction and/or posting data. As described in more detail below, the historical transaction and/or posting data may be employed to train a predictive model to provide an output that indicates predictions, and the current transaction and/or posting data is thereafter analyzed by the predictive model. Moreover, as time goes by, and results become known from processing current transaction and/or postings, at least some of the current transaction and/or postings may be used to perform further training of the predictive model. Consequently, the predictive model may thereby adapt itself to changing landscapes.

Either the historical transaction and/or posting data or the current transaction and/or posting data might include, according to some embodiments, determinate and indeterminate data. As used herein and in the appended claims, “determinate data” refers to verifiable facts such as a merchant identifier, transaction amount, a geographic location, address or ZIP code and a payment account number.

As used herein, “indeterminate data” refers to data or other information that is not in a predetermined format and/or location in a data record or data form. Examples of indeterminate data include narrative speech or text, information in descriptive notes fields, tags and hashtags, and signal characteristics in audible voice data files. Indeterminate data extracted from social media posts might be associated with, for example, key words and phrases. Examples of the indeterminate data capture module(s) may include one or more optical character readers, a speech recognition device (i.e., speech-to-text conversion), a computer or computers programmed to perform natural language processing, a computer or computers programmed to identify and extract information from narrative text files, a computer or computers programmed to detect key words in text files, and a computer or computers programmed to detect indeterminate data regarding an individual.

The predictive model 1152 may effectively be implemented via a computer processor, one or more application programs stored in the program memory, and data stored as a result of training operations based on the historical transaction and/or posting data. In some embodiments, data arising from model training may be stored in the data storage module, or in a separate data store. A function of the predictive model 1152 may be to determine appropriate simulation models, results, and/or scores. The predictive model 1152 may operate generally in accordance with conventional principles for predictive models, except, as noted herein, for at least some of the types of data to which the predictive model component is applied. Those who are skilled in the art are generally familiar with programming of predictive models. It is within the abilities of those who are skilled in the art, if guided by the teachings of this disclosure, to program a predictive model to operate as described herein. A model training component may have the function of training the predictive model 1152 based on the historical transaction and/or posting data.

Thus, embodiments may provide an automated and efficient way to facilitate payment account fraud detection using social media heat maps. Some embodiments may provide integrated robust fraud analytic capabilities with an integrated decision management platform to provide a real time and managed service focused on identifying risks.

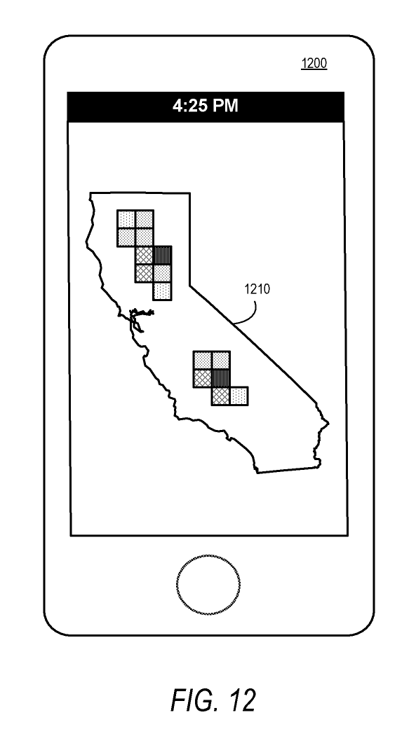

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims. Moreover, the displays provided in connection with FIGS. 4 through 8 are for illustration only, and different types of maps and/or display devices might be used instead. For example, FIG. 12 is an example of a smartphone 1200 displaying a payment fraud detection social media heat map display 1210 in accordance with any of the embodiments described herein.

What is claimed is:

1. A system to facilitate payment account fraud detection, comprising:
a communication port programmed to:
(i) collect information associated with a plurality of social media accounts over a period of time;
a fraud data computer store to store the information associated with the plurality of social media accounts; and
a fraud detection computer server, coupled to the communication port and the fraud data computer store, programmed to:
(ii) retrieve the information associated with the plurality of social media accounts,
(iii) determine a sub-set of social media accounts meeting a potential fraud threshold associated with at least one type of payment account,
(iv) for each of the sub-set of social media accounts meeting the potential fraud threshold, determine a geographic location associated with the social media account, and
(v) render a map display indicating the geographic locations of the sub-set of social media accounts meeting the potential fraud threshold.

2. The system of claim 1, wherein the communication port collects information from at least one social media platform using an application programming interface and said rendering is performed in substantially real time.

3. The system of claim 1, wherein a user defines at least one of: the period of time, the plurality of social media accounts, the at least one type of payment account, and the potential fraud threshold.

4. The system of claim 1, wherein the at least one type of payment account is associated with at least one of: a credit card account, a debit card account, a bank account, and a pre-paid stored value account.

5. The system of claim 1, wherein the information associated with the social media accounts include at least one of: text information, image information, a social media post, a social media re-post, a social media message, and a social media rating indication.

6. The system of claim 5, wherein the potential fraud threshold comprises the presence of at least one key word or key phrase in the information collected for a social media account.

7. The system of claim 1, wherein the geographic location information is associated with at least one of: a latitude and longitude, a ZIP code, a town, a state, a county, and a country.

8. The system of claim 1, wherein the rendered map display includes icons selected based at least in part on a number of social media accounts meeting the potential fraud threshold in connection with a particular geographic location, wherein different icons may be associated with different: icon sizes, icon shapes, and icon colors.

9. The system of claim 1, wherein the rendered map display includes icons selected based at least in part on a change in a number of social media accounts meeting the potential fraud threshold in connection with a particular geographic location, wherein different icons may be associated with different: icon sizes, icon shapes, and icon colors.

10. The system of claim 1, wherein the fraud detection computer server is further programmed to:
(vi) retrieve information about confirmed fraud transactions that have occurred, and
(vii) display information about the confirmed fraud transactions on the map display.

11. The system of claim 1, wherein the fraud detection computer server is further programmed to:
(vi) retrieve information about confirmed fraud transactions that have occurred, and
(vii) adjust at least one fraud model in accordance with the information about confirmed fraud transactions that have occurred and the sub-set of social media accounts meeting the potential fraud threshold.

12. The system of claim 11, wherein fraud model includes logic associated with at least one of: card present transactions, card not present transactions, cross border transactions, domestic transactions, retail shopper transactions, domestic automated teller machine transactions, cross border automated teller machine transactions, travel spending transactions, signature at personal identification number terminal transactions, automotive fuel dispenser transactions, online transactions, game transactions, gambling transactions, a transaction amount, and a transaction time of day.

13. A method to facilitate payment account fraud detection, comprising:
collecting information associated with a plurality of social media accounts over a period of time;
determining, by a fraud detection computer server, a sub-set of social media accounts meeting a potential fraud threshold associated with at least one type of payment account;
for each of the sub-set of social media accounts meeting the potential fraud threshold, determining, by the fraud detection computer server, a geographic location associated with the social media account; and
rendering, by the fraud detection computer server, a map display indicating the geographic locations of the sub-set of social media accounts meeting the potential fraud threshold.

14. The method of claim 13, wherein the information is collected from at least one social media platform using an application programming interface and said rendering is performed in substantially real time.

15. The method of claim 13, wherein a user defines at least one of: the period of time, the plurality of social media accounts, the at least one type of payment account, and the potential fraud threshold.

16. The method of claim 13, wherein the at least one type of payment account is associated with at least one of: a credit card account, a debit card account, a bank account, and a pre-paid stored value account.

17. The method of claim 13, wherein the information associated with the social media accounts include at least one of: text information, image information, a social media post, a social media re-post, a social media message, and a social media rating indication.

18. The method of claim 17, wherein the potential fraud threshold comprises the presence of at least one key word or key phrase in the information collected for a social media account.

19. The method of claim 13, wherein the geographic location information is associated with at least one of: a latitude and longitude, a ZIP code, a town, a state, a county, and a country.

20. The method of claim 13, wherein the rendered map display includes icons selected based at least in part on a number of social media accounts meeting the potential fraud threshold in connection with a particular geographic location, wherein different icons may be associated with different: icon sizes, icon shapes, and icon colors.

21. A non-transitory, computer readable medium having stored therein instructions that, upon execution, cause a computer to perform a method to facilitate payment account fraud detection, the method comprising:
collecting information associated with a plurality of social media accounts over a period of time;
determining a sub-set of social media accounts meeting a potential fraud threshold associated with at least one type of payment account;
for each of the sub-set of social media accounts meeting the potential fraud threshold, determining a geographic location associated with the social media account; and
rendering a map display indicating the geographic locations of the sub-set of social media accounts meeting the potential fraud threshold.
